(19) United States
(12) Patent Application Publication
(10) Pub. No.: US 2016/0003777 A1
(43) Pub. Date: Jan. 7, 2016

(54) RECORDING DEVICE AND RECORDING METHOD

(71) Applicants: CARL ZEISS AG, Oberkochen (DE); CARL ZEISS MICROSCOPY GMBH, Jena (DE)

(72) Inventors: Tobias Schmitt-Manderbach, Jena (DE); Gerhard Krampert, Jena (DE); Wibke Hellmich, Jena (DE); Helmut Lippert, Jena (DE)

(21) Appl. No.: 14/771,463

(22) PCT Filed: Feb. 14, 2014
(86) PCT No.: PCT/EP2014/052915

§ 371 Date: Aug. 28, 2015

(30) Foreign Application Priority Data
Feb. 28, 2013 (DE) 10 2013 203 454.7

(51) Int. Cl. G01N 29/06

(52) U.S. Cl. CPC G01N 29/0654

(57) ABSTRACT

The invention relates to a recording device comprising an excitation module (2, 10; 9, 10) which stimulates the sample (3) for emitting pressure waves, an acoustic module (9, 10) for detecting the generated pressure waves, and a control module (10) which determines an acoustic image based on the data from the acoustic module (9, 10). Said recording device also comprises a reproduction module (5) for optically reproducing the sample (3) and the control module (10) determines a sample limit and/or a segment limit within the sample (3) based on the optical reproduction of the sample (3) and when the acoustic image is detected, the determined sample limit and/or segment limit are taken into consideration.

The invention concerns a recording device with an excitation module which stimulates a sample for reproducing of pressure waves, an acoustic module for detecting the generated pressure waves, and a control module which determines an acoustic image based on the data from the acoustic module.

The excitation module for example can illuminate the sample (or a portion thereof) with a laser pulse (such as a nanosecond pulse). At least a portion of the introduced optical energy is absorbed by structures in the sample, which leads to a local heating and a subsequent thermoelastic expansion and thus a sonic wave. The sonic wave is detected by means of the acoustic module and can therefore be used to generate a location-resolved image.

The created acoustic images can have artifacts, which are attributable to, for example, a refraction of the sonic waves being detected at a boundary between the sample and the surrounding medium. Moreover, inhomogeneities within the sample which are present for example due to different types of tissue can lead to artifacts in the generated acoustic image.

Based on this, the problem which the invention proposes to solve is to provide a recording device of the above mentioned kind in which the detected acoustic image has the fewest possible artifacts. Moreover, a corresponding recording method should be provided.

According to the invention, the problem is solved by a recording device with an excitation module which stimulates the sample for emitting pressure waves, an acoustic module for detecting the generated pressure waves, and a control module which determines an acoustic image based on the data from the acoustic module, wherein the recording device also comprises a reproduction module for optically reproducing the sample and the control module determines a sample limit and/or a segment limit (or also segment limits) within the sample based on the optical reproduction of the sample and when the acoustic image is detected, the determined sample limit and/or segment limit(s) are taken into consideration. By sample and/or segment limit or segment limits is meant here in particular the entire sample or segment limit or also only a portion of the sample and/or segment limit.

Thanks to this optical detection of the sample limit and/or segment limit(s) these limits can be taken into account when detecting the acoustic image (e.g., in the corresponding calculation algorithms), so that the artifacts can be reduced in the generated location-resolved acoustic image.

In particular, the control module can determine the sample and/or segment limit(s) based on a two-dimensional optical recording or a three-dimensional optical recording.

Moreover, the control module can take into account the determined sample and/or segment limit(s) in an acoustic propagation model of the sample which is used for detecting the acoustic image.

In this way, it is possible to reduce the artifacts in the acoustic image.

The reproduction module for the optical reproduction can be configured as in a traditional microscope. In particular, the recording device can also have an illumination module to illuminate the sample. The illumination module can also be configured as in a traditional optical microscope.

In particular, any known optical imaging technique can be used for the optical recording, such as transmission light microscopy, incident light microscopy, optical projection tomography and/or microscopy with light sheet illumination for an optical section recording. In this, one can make use of phase, fluorescence and/or absorption contract, for example.

The reproduction module can be configured as a laser scanning microscope.

Moreover, the reproduction module can have a lens. The lens in particular can be an immersion lens.

The excitation module can be designed to subject the sample to electromagnetic radiation to generate the pressure waves. In particular, the excitation can be done through the reproduction module for the optical reproduction.

It is also possible for a pressure sensor of the acoustic module to be part of the excitation module and to be used to generate sonic waves directed at the sample.

In the recording device according to the invention, the reproduction module can have a lens, where the lens comprises a front lens at the sample side, establishing an optically utilized middle region, and the acoustic module has an annular pressure sensor, which is arranged in the region of the end of the lens at the sample side and whose internal diameter is chosen such that it does not cover the optically utilized middle region looking in the direction of the optical axis of the lens.

With such a recording device, advantageously the optical detection is not influenced, since the optically utilized middle region is not covered by the pressure sensor. On the other hand, thanks to the arrangement of the pressure sensor in the region of the end of the lens at the sample side, the necessary acoustic coupling between pressure sensor and sample can be achieved.

The pressure sensor can be fastened to a dampening body, which in turn is secured to the lens barrel. In this way, unwanted sound reflections on the lens barrel can be reduced.

Moreover, it is possible to arrange the pressure sensor at a distance from the lens, by this meaning in particular an arrangement in which there is no direct link between pressure sensor and lens. For example, the pressure sensor can be arranged on a cover glass or a specimen stage. An arrangement on a wall in a specimen chamber is also possible.

In the recording device according to the invention the lens can have a lens barrel and the pressure sensor can be fastened to the lens barrel. This accomplishes a very compact design.

The pressure sensor can have a piezoceramic transducer. Good sonic detection is possible with such a transducer.

Moreover, the pressure sensor can have an optically detectable property.

The lens can be designed as an immersion lens. This makes it possible for the immersion medium to also be in contact with the pressure sensor, so that a good optical coupling is possible.

The excitation module can be designed so that it subjects the sample to electromagnetic radiation to generate pressure waves. The electromagnetic radiation can be in particular radiation from the range of 300 nm to 3 pm, preferably 300 nm to 1300 nm, 300 nm to 1000 nm, 300 nm to 700 nm, 700 nm to 3 pm, 700 nm to 1300 nm or 700 nm to 1000 nm. In particular, it is pulsed laser light. The pulse length can lie in the ns region.

The pressure sensor can be part of the excitation module and be used to generate sonic waves directed onto the sample. In this case, the pressure sensor serves to generate pressure or sonic waves and to detect the sonic response coming back from the sample.

The recording device according to the invention can be designed as a microscope and can contain further units and modules known to the skilled person for the operating of the microscope.

The problem is furthermore solved by a recording method, wherein a sample is excited in order to put out pressure waves, the excited pressure waves are detected, and an acoustic image is detected based on the detected pressure waves, wherein moreover an optical reproduction of the sample is performed and based on the optical reproduction of the sample a sample limit and/or a segment limit (or also segment limits) is determined inside the sample and the determined sample and/or segment limit(s) are taken into account during the detection of the acoustic image.

The recording method according to the invention can be modified so that the steps of the method as described can be carried out with the recording device according to the invention (including the described modification). Moreover, the recording device according to the invention can be modified so that the steps of the method as described can be carried out with the recording method according to the invention (including the modifications).

Of course, the above mentioned and yet to be explained features can be used not only in the indicated combinations, but also in other combinations or standing alone, without leaving the scope of the present invention.

The invention will be explained more closely below with the aid of the enclosed drawings, which also disclose features essential to the invention. There are shown:

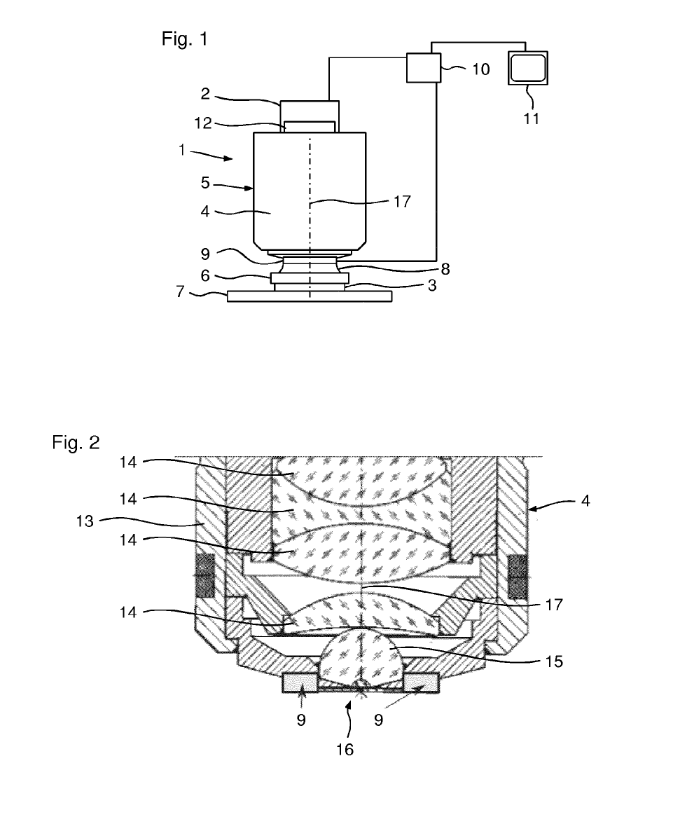

FIG. 1, a schematic view of a first embodiment of the recording device according to the invention;

FIG. 2, an enlarged sectional view of the end of the lens 4 at the sample side in FIG. 1;

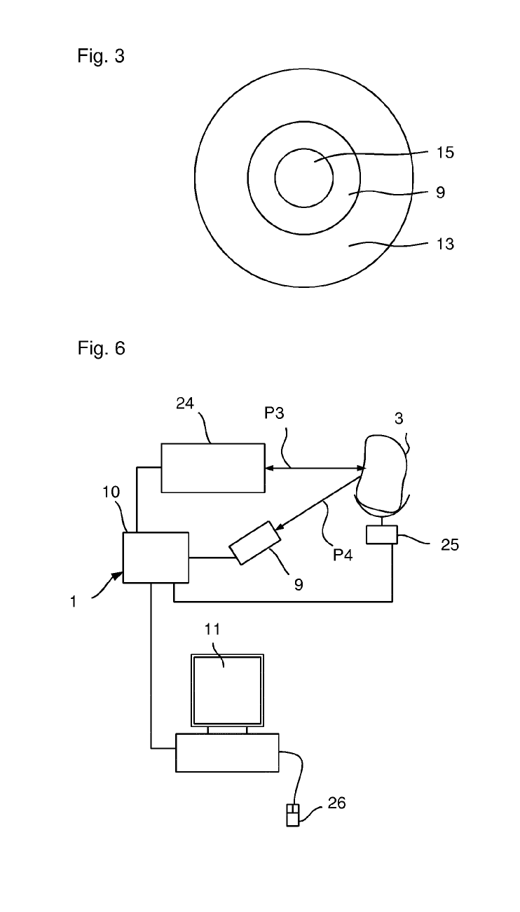

FIG. 3, a view from below looking at the lens 4 of FIGS. 1 and 2;

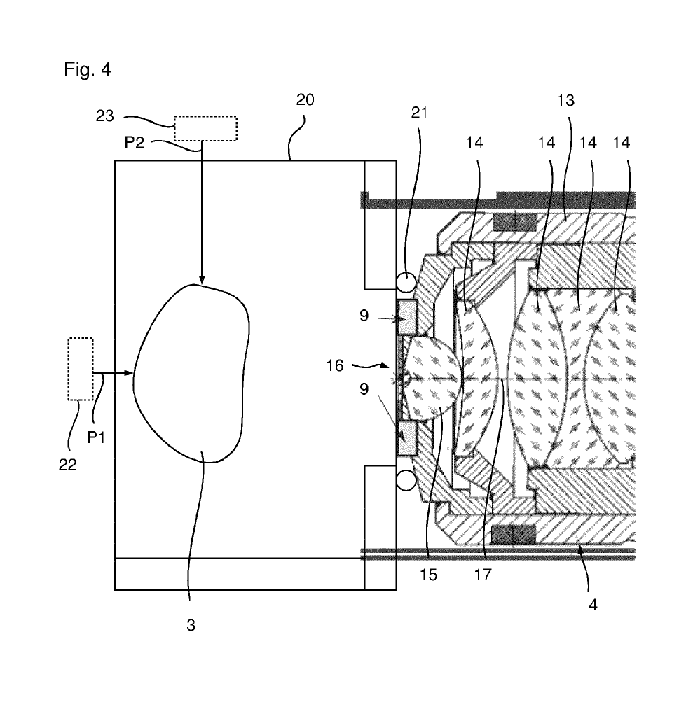

FIG. 4, a schematic sectional view of another embodiment of the recording device according to the invention;

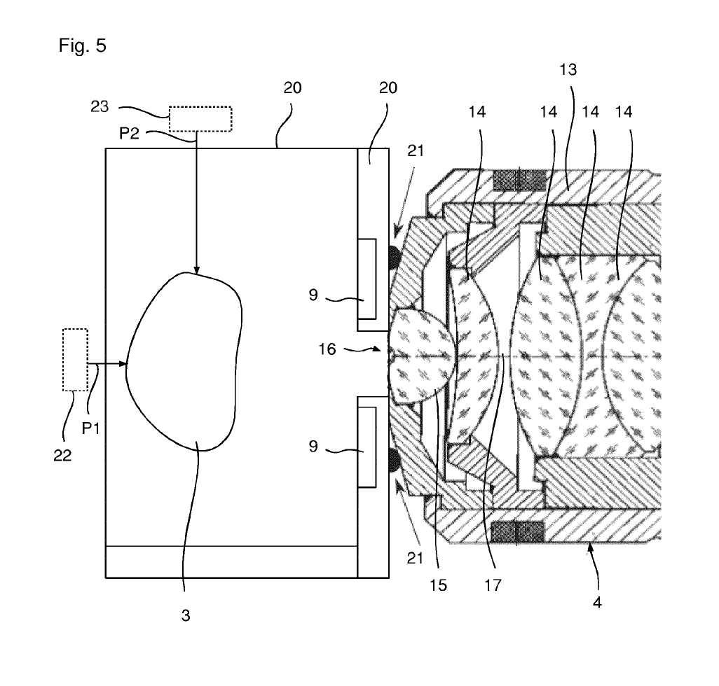

FIG. 5, a sectional view of another embodiment of the recording device according to the invention, and

FIG. 6, a schematic view of another embodiment of the recording device according to the invention.

In the embodiment shown in FIG. 1, the recording device 1 according to the invention is configured as a microscope and comprises an illumination module 2 for illuminating a sample 3 and a reproduction module 5 having a lens 4 for the imaging of the sample 3.

The lens 4 is designed as an immersion lens. Therefore, in the schematic representation of FIG. 1, next to the sample 3 which lies between a cover glass 6 and a specimen stage 7 there is shown an immersion medium 8 between the cover glass 6 and the end of the lens 4 facing the cover glass 6.

Moreover, the microscope 1 comprises an annular pressure sensor 9, which is arranged on the cover glass 6 or the end of the lens 4 facing the sample 3, a control module 10 and an output unit 11.

By means of the control module 10 the illumination module 2 can be actuated so that it generates pulsed electromagnetic radiation in the range of, e.g., 300 nm to 3 pm (hereinafter also called excitation radiation), which is focused by a deflection unit 12 contained in the illumination module 2 and the lens 4 on the sample 3 (e.g., as a focal spot) and moved in the latter. A portion of the energy introduced in this way is absorbed by structures in the sample 3, resulting in a local heating and subsequent thermoelastic expansion and thus a pressure or sonic wave.

The sonic wave, if the sample 3 is a biological specimen, for example, is very little scattered upon propagation through the sample and can therefore serve to generate a location-resolved image, a large depth of penetration being possible during the imaging of greater than 1 mm, for example. The annular pressure sensor 9 is used for the detection of the sonic waves.

As can be seen from the enlarged sectional representation of the end of the lens 4 at the sample side in FIG. 2, the lens 4 comprises a lens barrel 13, in which several lenses 14 and a front lens 15 at the sample side are arranged. The front lens 15 establishes an optically utilized middle region 16, which is used to subject the sample to the pulsed excitation radiation and for a traditional optical imaging of the sample 3 via the lens. At the front end of the lens 4 is placed the annular pressure sensor 9, the internal diameter and the position of the pressure sensor 9 being chosen such that, looking in the direction of the optical axis 17 of the lens 4, the pressure sensor 9 does not cover the optically utilized middle region 16. The pressure sensor 9, which can also be termed an ultrasound sensor, can be formed from a piezoceramic, so that a good detection of the sonic waves is possible. Thanks to the arrangement of the pressure sensor 9 at the front end of the lens 4, the pressure sensor 9 is in contact with the immersion medium 8 during the operation of the microscope 1, so that a good acoustic coupling exists between the sample 3 and the pressure sensor 9.

The pressure sensor 9, as shown schematically in FIG. 1, is connected to the control module 10. The control module 10 can generate image data based on the measurement data of the pressure sensor 9, so that a photoacoustic imaging is realized. The image data can be displayed, for example, by the output unit 11.

Thanks to the arrangement of the pressure sensor 9 according to the invention, there is no restriction of the function of the lens 4, so that a traditional light microscopy with the lens 4 remains possible. This can be used to record a preview contrast image, a fluorescence contract image, etc.

Moreover, the high numerical aperture of the immersion lens 4 can be utilized to create a very small focus of the excitation radiation in the sample 3 for the excitation of the pressure waves. In this way, a localized excitation of the sample 3 with the pulsed excitation radiation (such as laser radiation with ns pulses) is possible, thereby achieving a high spatial resolution in the photoacoustic imaging mode. The excitation radiation (especially laser radiation) producing the pressure waves can sweep the sample 3 in a plane perpendicular to the optical axis 17. This can be accomplished, for example, by a scan mirror (not shown) of the deflection unit 12 arranged in the pupil of the lens 4, as is usually the case in laser-scanning microscopes. In addition, the pulsed excitation radiation can scan the sample 3 in the direction of the optical axis 17 by appropriately adjusting the focal plane of the excitation radiation. Alternatively or additionally, the sample 3 can also be moved accordingly.

Thanks to the arrangement of the annular pressure sensor 9 at the front end of the lens barrel 13 according to the invention, there is compatibility with existing microscope systems. All one needs to do is employ the lens according to the invention in existing microscope systems.

As already explained, the control module 10 can create acoustic image data based on the measurement data of the pressure sensor 9.

The acoustic image data created may contain artifacts, which are attributable e.g. to a refraction of the pressure or sonic waves being detected at the boundary between the sample 3 and the surrounding medium 8. Inhomogeneities within the sample 3 which are present on account of different kinds of tissue, for example, can also result in artifacts in the acoustic image. Thus, for example, the speed of sound in bone, lung and brain tissue is distinctly different, which generally results in refraction and reflection of the sonic waves at the tissue boundaries.

Therefore, in the recording device 1 according to the invention, an optical imaging of the sample is carried out in addition. Based on the optical imaging of the sample, the control module 10 detects the sample limit and/or a segment limit (or also segment limits) within the sample. By a segment limit is meant here in particular a boundary at which an essentially constant acoustic property changes within the sample. This optically determined sample and/or segment limit is taken into account by the control module when detecting the acoustic image based on the data of the pressure sensor 9. Thus, e.g., the control module 10 can use the information regarding the sample and/or segment limit during the acoustic image determination or image reconstruction as a parameter and/or boundary condition. For example, these limits can be taken into account for reconstruction of the acoustic image in an acoustic propagation model which is being used.

Thus, one can say that, according to the invention, a region or regions with at least approximately constant acoustic impedance is derived from the optical image. Insofar as no direct inferences as to the specific value of the acoustic impedance in a particular region can be derived from the optical image, empirical values or other meaningful values can also be used. These values can be stored in a database which is contained in the control module 10 or which is accessible to the control module 10. These saved values can be automatically selected by the control module 10 based on the shape and/or extent of the particular sample segment or sample region, for example. This will then be factored into the acoustic image reconstruction, thereby reducing the artifacts in the acoustic image.

The optical imaging of the sample can be done in the most diverse of ways. It can be done in the device for the acoustic detection, as already described. However, it can also be done in a separate device.

As the optical imaging technique one can employ for example transmission light microscopy, incident light microscopy, optical projection tomography and/or microscopy with light sheet illumination for an optical section recording. Moreover, one can make use of phase, fluorescence and/or absorption contrast, for example. The optical recordings of the sample can be two-dimensional recordings or three-dimensional recordings. Several optical recordings can be performed to create three-dimensional recordings. For this, the sample and/or the recording device 1 can be rotated between the individual recordings themselves, for example.

The optical imaging of the sample can be done under an illumination with only one wavelength, several wavelengths, or one wavelength region.

Besides the type of acoustic detection described here, other acoustic detections known to the skilled person are also possible.

FIG. 3 shows a view from below of the front end of the lens 4. Once again it is clearly seen here that the pressure sensor 9 encircles the front lens 15 and does not cover it and thus also does not cover the optically utilized middle region 16 of the front lens 15.

The pressure sensor 9 can be provided with a protective jacket for better cleaning or protection. This can be a plastic jacket.

Moreover, the pressure sensor 9 need not be fastened directly to the lens barrel 13, but rather a dampening body (not shown) can be arranged between the pressure sensor 9 and the lens barrel 13. In this way, a rear-side decoupling of the pressure sensor 9 from the lens barrel 13 can be achieved to prevent sound reflection.

FIG. 1 shows schematically a separate connection of the control module 10 to the pressure sensor 9. Of course, in an electrical contacting for example, the lens 4 can also be designed so that the electrical contacts are arranged in the lens flange.

The layout of the microscope according to the invention that is shown in FIG. 1 is only an example. Other variants are also possible, of course, besides the incident light layout shown in FIG. 1. Thus, the microscope can also be designed as an inverted microscope, in which the lens 4 is arranged underneath the sample 3.

Moreover, it is possible for the lens 4 to look sideways into a water-filled specimen chamber 20, as is represented schematically in FIG. 4. In this embodiment, a seal is realized between the lens barrel 13 and the specimen chamber 20 e.g. by the schematically indicated O-ring 21. Moreover, besides the already described illumination via the lens 4, there can also be a transmitted light illumination with an optional illumination module 22 (shown by dotted line) and/or a sideways light sheet illumination with a further optional illumination module 23 (shown by dotted line). These possible illuminations are indicated by the arrows P1 and P2.

FIG. 5 shows a modification of the embodiment of FIG. 4. In this modification, the annular pressure sensor 9 is no longer fastened directly to the lens barrel 13, but rather in the specimen chamber wall 22 facing the lens 4. Once again, the pressure sensor 9 here is arranged so that, looking in the direction of the optical axis 17, it does not cover the optically utilized middle region 16 of the front lens 15. Moreover, it is arranged in the specimen chamber wall 22 such that it is in contact with the water in the specimen chamber 20 or the other medium in the specimen chamber 20 in order to realize the desirable good sonic coupling.

FIG. 6 shows another embodiment of the recording device 1 according to the invention, where the recording device 1 according to the invention has an optics module 24 for the optical imaging of the sample 3, as indicated by the double arrow P3. The optics module 24 can contain, e.g., an illumination module and a reproduction module.

Moreover, the recording device 1 comprises a holding mechanism 25, which is actuated by the control module 10. The control module 10 is also in connection with the optics module 24 and the pressure sensor 9. As indicated by the arrow P4, the pressure waves are detected by means of the pressure sensor 9.

By means of the holding mechanism 25 the sample 3 can be rotated in order to take the desired optical and/or acoustic recordings.

Moreover, an input unit 26 can also be provided optionally, as is indicated schematically by the computer mouse. Through the input unit it is possible to make entries in the control module 10.

In the embodiments described thus far, the excitation of the sonic waves was always done optically. However, it is also possible to use the pressure sensor 9 to generate sound. In this type of detection, the control module 10 actuates the pressure sensor 9 so that it sends sonic waves for a predetermined time into the sample 3 and detects the sonic response coming back from the sample 3. The frequencies of the ultrasonic waves lie for example at 20 MHz or greater.

As was already explained, the pressure sensor 9 can be formed from a piezoceramic. Thus, one can utilize the piezoelectric effect to transform sonic energy into electrical signals for the pressure detection. The piezoelectric effect can also be utilized to transform electrical signals into pressure signals, in the event that the pressure sensor 9 is being used as a sound source.

Besides this kind of pressure detection, any other kind of pressure detection is also possible. Thus, e.g., a Fiber-Bragg sensor or a waveguide structure can be used for an optical detection of the ultrasonic waves. In this case, there is present an optically detectable, pressure-dependent property of the sensor, which is optically detected. The pressure sensor can be designed as a resonant and/or broadband pressure sensor.

The microscope 1 according to the invention can be designed so that the excitation of the pressure waves being detected is possible optically and/or through sonic waves.

1. A recording device comprising:
an excitation module, which stimulates a sample for emitting pressure waves;
an acoustic module for detecting the generated pressure waves, and a control module which determines an acoustic image based on data from an acoustic module, wherein the recording device also comprises a reproduction module for optically reproducing the sample and the control module determines a sample limit and/or or a segment limit within the sample and when the acoustic image is detected, the determined sample limit and/or or segment limit is taken into consideration; and
wherein the control module takes into account the determined sample or segment limit in an acoustic propagation model of the sample which is used for detecting the acoustic image.

2. The recording device according to claim 1, wherein the control module determines the sample and/or or segment limit based on a two-dimensional optical recording.

3. The recording device according to claim 1, wherein the control module determines the sample and/or or segment limit based on a three-dimensional optical recording.

4. (canceled)

5. The recording device according to claim 1, wherein the recording device further comprises an illumination module for illuminating a sample.

6. The recording device according to claim 1, wherein the reproduction module has a lens.

7. The recording device according to claim 6, wherein the lens is designed as an immersion lens.

8. The recording device according to claim 1, the excitation module is designed to subject the sample to electromagnetic radiation to generate pressure waves.

9. The recording device according to claim 1, wherein a pressure sensor of the acoustic module is part of the excitation module and is used to generate sonic waves directed at the sample.

10. A recording method, wherein a sample is excited in order to output pressure waves, the excited pressure waves are detected, and an acoustic image is detected based on the detected pressure waves, wherein moreover an optical reproduction of the sample is performed and based on the optical reproduction of the sample a sample limit and/or a segment limit is determined inside the sample and the determined sample and/or segment limit is taken into account during the detection of the acoustic image.
